(19) United States
(12) Patent Application Publication
(10) Pub. No.: US 2018/0160125 A1
(43) Pub. Date: Jun. 7, 2018

(54) STEREOSCOPIC IMAGE STREAM PROCESSOR AND STEREOSCOPIC IMAGE STREAM PROCESSING METHOD

(71) Applicant: MStar Semiconductor, Inc., Hsinchu Hsien (TW)

(72) Inventors: CHUNG-YI CHEN, Hsinchu County (TW); HSUN-HAO CHANG, Hsinchu County (TW); YUCHENG TSENG, Hsinchu County (TW)

(21) Appl. No.: 15/828,773

(22) Filed: Dec. 1, 2017

Related U.S. Application Data
(60) Provisional application No. 62/429,876, filed on Dec. 5, 2016.

(51) Int. Cl. H04N 19/172; H04N 19/42; H04N 19/513

(52) U.S. Cl. CPC H04N 19/172; H04N 19/12; H04N 19/513; H04N 19/42

(57) ABSTRACT

A stereoscopic image stream processing device includes: a decompressor, decompressing a stereoscopic image stream to obtain a series of video frames, a merged frame format and an image resolution; a motion estimation and motion compensation module, performing a motion estimation process and a motion compensation process based on the series of video frames to obtain a series of compensated frames, and dividing the series of compensated frames into a series of left image frames and a series of right image frames; a scaling ratio determiner, determining a horizontal scaling ratio and a vertical scaling ratio according to the merged frame format, the image resolution and a display resolution; and a scaler, scaling the series of left image frames and the series of right image frames to obtain a series of left scaled frames and a series of right scaled frames.

This application claims the benefit of U.S. Provisional Application Ser. No. 62/429,876, filed on Dec. 5, 2016, the subject matter of which is incorporated herein by reference.

### BACKGROUND OF THE INVENTION

### Field of the Invention

The invention relates image stream processing, and more particularly to stereoscopic image stream processing.

### Description of the Related Art

In common stereoscopic image stream processing, a stereoscopic image stream is decompressed by a decompressor to obtain a series of video frames. To obtain better image quality, before motion estimation and motion compensation are performed, the series of video frames are first scaled to a final display resolution (i.e., the resolution of a display device). In other words, the series compensated frames generated after the motion estimation and motion compensation are not further scaled.

However, because each video frame is a picture including a plurality of color pixels, the data size of this series of video frames is extremely large, and the data size can become even larger after the scaling, resulting in the occupying of a big bandwidth when the motion estimation and motion compensation are performed. Therefore, there is a need for a solution capable of reducing a bandwidth usage.

### SUMMARY OF THE INVENTION

It is a primary object of the present invention to provide a stereoscopic image stream processing device capable of reducing an amount of bandwidth used.

The present invention discloses a stereoscopic image stream processing device. The stereoscopic image stream processing device includes: a decompressor, decompressing a stereoscopic image stream to obtain a series of video frames, a merge frame format and an image resolution; a motion estimation and motion compensation module, performing a motion estimation process and a motion compensation process based on the series of video frames to obtain a series of compensated frames, and dividing the series of compensated frames into a series of left image frames and a series of right image frames according to the merged frame format and the image resolution; a scaling ratio determiner, determining a horizontal scaling ratio and a vertical scaling ratio according to the merged frame format, the image resolution and a display resolution; and a scaler, scaling the series of left image frame and the series of right image frames according to the horizontal scaling ratio and the vertical scaling ratio to obtain a series of left scaled frames and a series of right scaled frames.

The present invention further discloses a stereoscopic image stream processing method. The stereoscopic image stream processing method includes: decompressing a stereoscopic image stream to obtain a series of video frames, a merged frame format and an image resolution; performing a motion estimation process and a motion compensation process based on the series of video frames to obtain a series of compensated frames, and dividing the series of compensated frames into a series of left image frames and a series of right image frames according to the merged frame format and the image resolution; determining a horizontal scaling ratio and a vertical scaling ratio according to the image resolution and a display resolution; and scaling the series of left image frames and the series of right image frames according to the horizontal scaling ratio and the vertical scaling ratio to obtain a series of left scaled frames and a series of right scaled frames.

The above and other aspects of the invention will become better understood with regard to the following detailed description of the non-limiting embodiments. The following description is made with reference to the accompanying drawings.

### BRIEF DESCRIPTION OF THE DRAWINGS

FIG. 1 is a block diagram of a stereoscopic image stream processing device according to an embodiment of the present invention;

FIG. 2 is a flowchart of a stereoscopic image stream processing method according to an embodiment of the present invention;

FIG. 3 is a schematic diagram of a merged frame format;

FIG. 4 is a block diagram of a motion estimation and motion compensation (MEMO) module according to an embodiment of the present invention; and

FIG. 5 is a block diagram of a scaling ratio determiner according to an embodiment of the present invention.

### DETAILED DESCRIPTION OF THE INVENTION

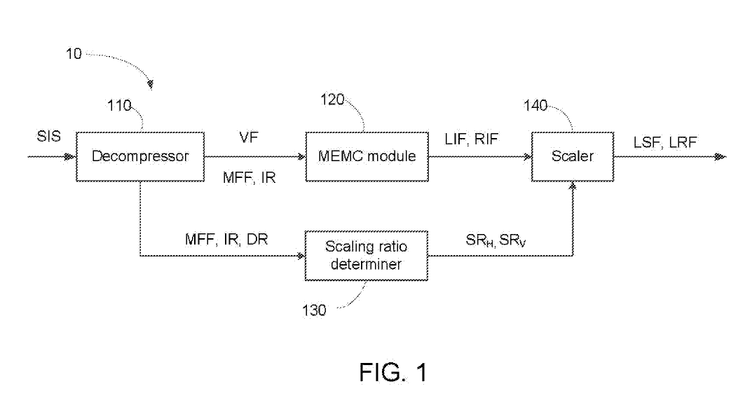

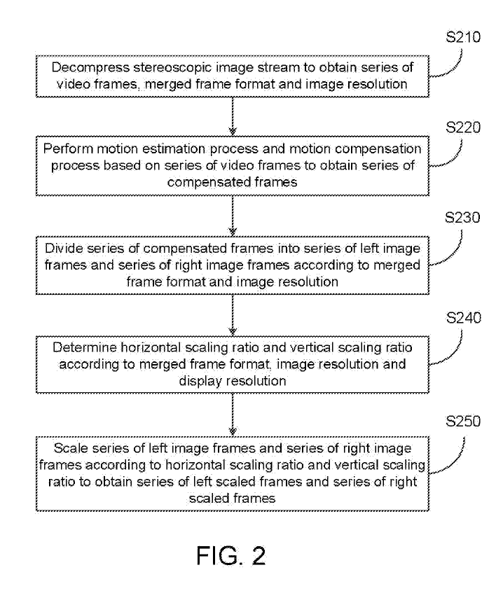

FIG. 1 is a block diagram of a stereoscopic image stream processing device 10 according to an embodiment of the present invention. The stereoscopic image stream processing device 10 includes a decompressor 110, a motion estimation and motion compensation (MEMO) module 120, a scaling ratio determiner 130 and a scaler 140. In practice, the decompressor 110, the MEMO module 120 and the scaler 140 may be implemented by an application-specific integrated circuit (ASIC); the scaling ratio determiner 130 may be implemented through executing an instruction stored in a memory by one or multiple processors. However, the present invention is not limited to the above examples. FIG. 2 shows a flowchart of a stereoscopic image stream processing method 20 according to an embodiment of the present invention. Details of the present invention with reference to FIG. 1 and FIG. 2 below.

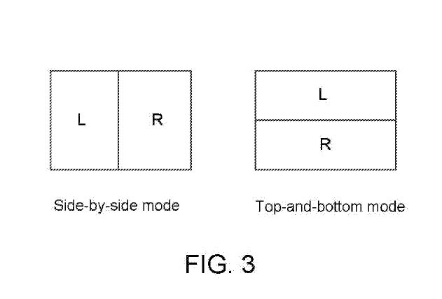

Image data includes a series of video frames VF. To accelerate storage or transmission, image data is usually compressed according to an image compression standard to reduce the data size of the image data. A stereoscopic image stream SIS includes compressed image data and information associated with the image data, e.g., a merged frame format MMF and an image resolution IR. The decompressor 110 decompresses the stereoscopic image stream SIS to obtain a series of video frames VF, the merged frame format MMF and the image resolution IR (step S210). The decompressor 110 may be, for example but not limited to, an MPEG-4 or H.264 decompressor, and the merged frame format is, e.g., a side-by-side mode or a top-and-bottom mode. For example, for the side-by-side mode, a left half of the video frame VF is a left-eye image and a right half of the video frame VF is a right-eye image, as shown in FIG. 3. In other embodiments, for the side-by-side mode, the left half of the video frame VF may be a right-eye image, and the right half of the video frame VF may be a left-eye image. For another example, for the top-and-bottom mode, the upper half of the video frame VF is a left-eye image, and the lower half of the video frame VF is a right-eye image, as shown in FIG. 3. In other embodiments, for the top-and-bottom mode, the upper half of the video frame VF may be a right-eye image and the lower half of the video frame VF may be a left-eye image. The image resolution IR is, for example but not limited to, SD (720*480), HD (1280*720), Full HD (1920*1080), or 4K (2840*2160).

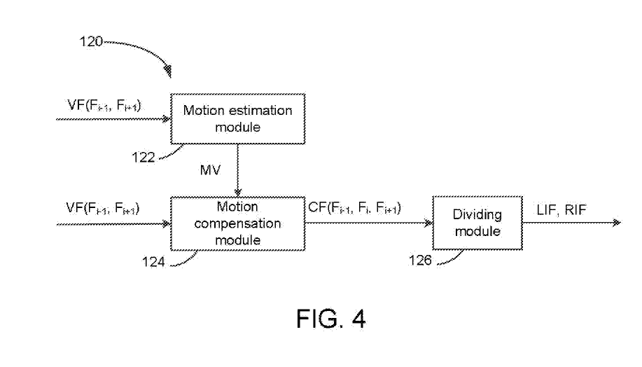

The MEMO module 120 receives the series of video frames VF and the merged frame format MMF from the decompressor 11, and performs a motion estimation process and a motion compensation process based on the series of video frames VF to obtain a series of compensated frames CF (step S220), and divides the series of compensated frames CF into a series of left image frames LIF and a series of right image frames RIF according to the image resolution IR (step S230). More specifically, FIG. 4 shows a block diagram of the MEMO module 120 according to an embodiment of the present invention. Referring to FIG. 4, the MEMO module 140 includes a motion estimation module 122, a motion compensation module 124 and a dividing module 126. The motion estimation module 122 first performs a motion estimation process to determine a motion vector MV between a previous frame Fᵢ₋₁ and a next frame Fᵢ₊₁ among the series of video frames VF. The motion compensation module 124 performs a motion compensation process according to the motion vector MV to generate an interpolation frame Fᵢ from the previous frame Fᵢ₋₁ and the next frame Fᵢ₊₁, and inserts the interpolation frame Fᵢ into the series of video frames VF to obtain the series of compensated frames CF. Details of the motion estimation process and the motion compensation process are generally known to one skilled in the art, and shall be omitted herein.

The dividing module 126 divides the series of compensated frames CF into a series of left image frames LIF and a series of right image frames RIF according to the merged frame format MMF and the image resolution IR. For example, when the merged frame format MMF is the side-by-side mode and the image resolution IR is fx*fy, the dividing module 126 divides a compensated frame CFᵢ into a left image frame LIFᵢ having a resolution (fx/2)*fy and a right image frame RIFᵢ having a resolution (fx/2)*fy. For example, when the merged frame format MMF is the side-by-side mode and the image resolution is 1920*1080, in one embodiment, the dividing module 126 divides a compensated frame CFᵢ into a left half as a left image frame LIFᵢ having a 960*1080 resolution, and a right half as a right image frame RIFᵢ having a 960*1080 resolution. In another embodiment, the dividing module 126 divides a compensated frame CFᵢ into a right half as a left image frame LIFᵢ having a 960*1080 resolution, and a left half as a right image frame RIFᵢ having a 960*1080 resolution.

For another example, when the merged frame format MMF is the top-and-bottom mode and the image resolution IR is fx*fy, the dividing module 126 divides a compensated frame CFᵢ into a left image frame LIFᵢ having a resolution of fx*(fy/2) and a right image frame RIFᵢ having a resolution of fx*(fy/2). For example, when the merged frame format MMF is the top-and-bottom mode and the image resolution is 1920*1080, in one embodiment, the dividing module 126 divides a compensated frame CFᵢ into an upper half as a left image frame LIFᵢ having a 1920*540 resolution, and a lower half as a right image frame RIFᵢ having a 1920*540 resolution. In another embodiment, the dividing module 126 divides a compensated frame CFᵢ into a lower half as a left image frame LIFᵢ having a 1920*540 resolution, and an upper half as a right image frame RIFᵢ having a 1920*540 resolution.

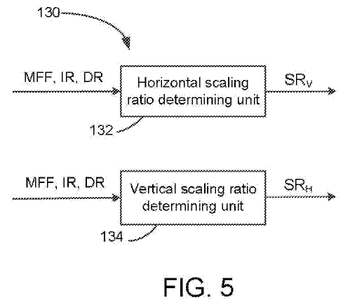

The scaling ratio determiner 130 determines a horizontal scaling ratio SR_{H} and a vertical scaling ratio SR_{V} according to the merged frame format MMF, the image resolution IR and a display resolution DR (step S240). FIG. 5 shows a block diagram of the scaling ratio determiner 130 according to an embodiment of the present invention. More specifically, referring to FIG. 5, the scaling ratio determiner 130 includes a horizontal scaling ratio determining unit 132 and a vertical scaling ratio determining unit 134. In one embodiment, when the merged frame format MMF is the side-by-side mode, according to the image resolution IR=fx*fy and the display resolution DR=dx*dy, the horizontal scaling ratio determining unit 132 obtains that the horizontal scaling ratio SR_{H} is 2*dx/fx, and the vertical scaling ratio determining unit 134 obtains that the vertical scaling ratio SR_{V} is dy/fy. For example, when the merged frame format MFF is the side-by-side mode, the image resolution IR is 1920*1080, and the display resolution DR is 1920*1080, the horizontal scaling ratio determining unit 132 accordingly determines that the horizontal scaling ratio SR_{H} is 2*1920/1920=2, and the vertical scaling ratio determining unit 134 accordingly determines that the vertical scaling ratio SR_{V} is 1080/1080=1. For another example, when the merged frame format MFF is the side-by-side mode, the image resolution IR is 1920*1080 and the display resolution DR is 3840*2160, the horizontal scaling ratio determining unit 132 accordingly determines the horizontal scaling ratio SR_{H} is 2*3840/1920=4, and the vertical scaling ratio determining unit 134 accordingly determines that the vertical scaling ratio SR_{V} is 2160/1080=2.

In another embodiment, when the merged frame format MFF is the top-and-bottom mode, according to the image resolution IR=fx*fy and the display resolution DR=dx*dy, the horizontal scaling ratio determining unit 132 accordingly determines that the horizontal scaling ratio SR_{H} is dx/fx, and the vertical scaling ratio determining unit 134 accordingly determines that the vertical scaling ratio SR_{V} is 2*dy/fy. For example, when the merged frame format MFF is the top-and-bottom mode, the image resolution IR is 1920*1080 and the display resolution DR is 3840*2160, the horizontal scaling ratio determining unit 132 accordingly determines that the horizontal scaling ratio SR_{H} is 3840/1920=2, and the vertical scaling ratio determining unit 134 accordingly determines that the vertical scaling ratio SR_{V} is 2*2160/1080=4.

The scaler 140 scales the left image frame LIFᵢ and the right image frame RIFᵢ according to the horizontal scaling ratio SR_{H} and the vertical scaling ratio SR_{V} to obtain a series of left scaled frames LSF and a series of right scaled frames RSF (step S250). For example, a row of pixel values in between are obtained from interpolation performed on an upper row and a lower row of pixel values, or a column of pixel values are obtained from performing interpolation on a left column and a right column of pixel values. Details of scaling are generally known to one person skilled in the art, and shall be omitted herein.

In conclusion, compared to prior art in which video frames are scaled to a final display resolution (i.e., the resolution of a display device) before motion estimation and motion compensation are performed, in the present invention, the video frames are scaled to a final display resolution needed only after motion estimation and motion compensation are performed. Thus, the bandwidth usage can be significantly reduced. It should be noted that, in another embodiment, the video frames may also undergo a first round of scaling before performing motion estimation and motion compensation, and then undergo a second round of scaling to a final display resolution required after the motion estimation and motion compensation are performed, thus obtaining better image quality. For example, in one embodiment, when the merged frame format MFF is the side-by-side mode, the image resolution IR is 1920*1080 and the display resolution DR is 3840*2160, the video frames VF may first be scaled up to 1920*2160 by a first scaler and then divided into a left image frame LIFᵢ and a right image frame IRFi having a 960*2160 resolution by an MEMO module, and then the left image frame LIFᵢ and the right image frame RIFᵢ are scaled up again by a second scaler to a left scaled frame LSF and a right scaled frame RSF having a 3840*2160 resolution. In another embodiment, when the merged frame format MFF is the top-and-bottom mode, the image resolution IR is 1920*1080 and the display resolution DR is 3840*2160, the video frames VF may first be scaled up to 1920*4320 by a first scaler and then divided into a left image frame LIFᵢ and a right image frame IRFᵢ having a 1920*2160 resolution by an MEMO module, and then the left image frame LIFᵢ and the right image frame RIFᵢ are scaled up again by a second scaler to a left scaled frame LSF and a right scaled frame RSF having a 3840*2160 resolution.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A stereoscopic image stream processing device, comprising:
a decompressor, decompressing the stereoscopic image stream to obtain a series of video frames, a merged frame format and an image resolution;
a motion estimation and motion compensation (MEMC) module, performing a motion estimation process and a motion compensation process based on the series of video frames to obtain a series of compensated frames, and dividing the series of compensated frames into a series of left image frames and a series of right image frames according to the merged frame format and the image resolution;
a scaling ratio determiner, determining a horizontal scaling ratio and a vertical scaling ratio according to the merged frame format, the image resolution and a display resolution; and
a scaler, scaling the series of left image frames and the series of right image frames according to the horizontal scaling ratio and the vertical scaling ratio to obtain a series of left scaled frames and a series of right scaled frames.

2. The stereoscopic image stream processing device according to claim 1, wherein the merged frame format comprises a side-by-side mode and a top-and-bottom mode.

3. The stereoscopic image stream processing device according to claim 2, wherein the MEMO module further comprises a dividing module, and when the merged frame format is the side-by-side mode and the image resolution is fx*fy, the dividing module divides a compensated frame into a left image frame having a resolution of (fx/2)*fy and a right image frame having a resolution of (fx/2)*fy.

4. The stereoscopic image stream processing device according to claim 2, wherein the MEMO module further comprises a dividing module, and when the merged frame format is the top-and-bottom mode and the image resolution is fx*fy, the dividing module divides a compensated frame into a left image frame having a resolution of fx*(fy/2) and a right image frame having a resolution of fx*(fy/2).

5. The stereoscopic image stream processing device according to claim 2, wherein the scaling ratio determiner comprises:
a horizontal scaling ratio determining unit, when the merged frame format is the side-by-side mode, the horizontal scaling ratio determining unit obtaining that the horizontal scaling ratio is 2*dx/fx according to the image resolution fx*fy and the display resolution dx*dy; and
a vertical scaling ratio determining unit, when the merged format is the side-by-side mode, the vertical scaling ratio determining unit obtaining that the vertical scaling ratio is dy/fy according to image resolution fx*fy and the display resolution dx*dy.

6. The stereoscopic image stream processing device according to claim 2, wherein the scaling ratio determiner comprises:
a horizontal scaling ratio determining unit, when the merged frame format is the top-and-bottom mode, the horizontal scaling ratio determining unit obtaining that the horizontal scaling ratio is dx/fx according to the image resolution fx*fy and the display resolution dx*dy; and
a vertical scaling ratio determining unit, when the merged format is the top-and-bottom mode, the vertical scaling ratio determining unit obtaining that the vertical scaling ratio is 2*dy/fy according to image resolution fx*fy and the display resolution dx*dy.

7. A stereoscopic image stream processing method, comprising:
decompressing the stereoscopic image stream to obtain a series of video frames, a merged frame format and an image resolution;
performing a motion estimation process and a motion compensation process based on the series of video frames to obtain a series of compensated frames, and dividing the series of compensated frames into a series of left image frames and a series of right image frames according to the merged frame format and the image resolution;
determining a horizontal scaling ratio and a vertical scaling ratio according to the merged frame format, the image resolution and a display resolution; and
scaling the series of left image frames and the series of right image frames according to the horizontal scaling ratio and the vertical scaling ratio to obtain a series of left scaled frames and a series of right scaled frames.

8. The stereoscopic image stream processing method according to claim 7, wherein the merged frame format comprises a side-by-side mode and a top-and-bottom mode.

9. The stereoscopic image stream processing method according to claim 8, wherein the step of dividing the series of compensated frames into the series of left image frames and the series of right image frames according to the merged frame format and the image resolution comprises:
when the merged frame format is the side-by-side mode and the image resolution is fx*fy, dividing a compensated frame into a left image frame having a resolution of (fx/2)*fy and a right image frame having a resolution of (fx*2)/fy.

10. The stereoscopic image stream processing method according to claim 8, wherein the step of dividing the series of compensated frames into the series of left image frames and the series of right image frames according to the merged frame format and the image resolution comprises:
when the merged frame format is the top-and-bottom mode and the image resolution is fx*fy, dividing a compensated frame into a left image frame having a resolution of fx*(fy/2) and a right image frame having a resolution of fx*(fy/2).

11. The stereoscopic image stream processing method according to claim 8, wherein the step of determining the horizontal scaling ratio and the vertical scaling ratio according to the merged frame format, the image resolution and the display resolution comprises:
when the merged frame format is the side-by-side mode, obtaining that the horizontal scaling ratio is 2*dx/fx according to the image resolution fx*fy and the display resolution dx*dy; and
when the merged format is the side-by-side mode, obtaining that the vertical scaling ratio is dy/fy according to image resolution fx*fy and the display resolution dx*dy.

12. The stereoscopic image stream processing method according to claim 8, wherein the step of determining the horizontal scaling ratio and the vertical scaling ratio according to the merged frame format, the image resolution and the display resolution comprises:
when the merged frame format is the top-and-bottom mode, obtaining that the horizontal scaling ratio is dx/fx according to the image resolution fx*fy and the display resolution dx*dy; and
when the merged format is the top-and-bottom mode, obtaining that the vertical scaling ratio is 2*dy/fy according to image resolution fx*fy and the display resolution dx*dy.
